(19) United States
(12) Patent Application Publication
(10) Pub. No.: US 2020/0278842 A1
(43) Pub. Date: Sep. 3, 2020

(54) Systems and Methods for Mining Software Repositories using Bots

(71) Applicant: Valorbec s.e.c, Montreal (CA)

(72) Inventors: Emad Shihab, Laval (CA); Ahmad Abdellatif, Montreal (CA)

(21) Appl. No.: 16/724,640

(22) Filed: Dec. 23, 2019

Related U.S. Application Data
(60) Provisional application No. 62/812,477, filed on Mar. 1, 2019.

(51) Int. Cl. G06F 8/36; H04L 12/58; G06F 40/295; G06N 3/04; G06N 5/02; G06F 9/54

(52) U.S. Cl. CPC G06F 8/36; H04L 51/02; G06F 9/54; G06N 3/04; G06N 5/02; G06F 40/295

(57) ABSTRACT

The present disclosure addresses the shortcomings of current systems and methods for mining software repositories. Accordingly, this disclosure describes how bots may be used to automate and ease the process of extracting useful information from software repositories. It lays out an approach of how bots, layered on top of software repositories, can be used to answer some of the most common software development/maintenance questions facing developers.

### RELATED APPLICATIONS

The present application claims priority to U.S. Provisional Application No. 62/812,477 which was filed on Mar. 1, 2019.

### TECHNICAL FIELD

The field of the present application is bots and mining software repositories (MSR).

### BACKGROUND

Software repositories contain an enormous amount of software development data. This repository data is very beneficial and has been mined to help to extract requirements, guide process improvements and improve quality. However, even with all of its success, the full potential of software repositories remains largely untapped. For example, recent studies presented some of the most frequent and urgent questions that software teams struggle to answer. Many of the answers to such questions can be found in repository data. Although software repositories contain a plethora of data, extracting useful information from these repositories remains to be a tedious and difficult task. Software practitioners (including developers, project managers, QA analysts, etc.) and companies need to invest significant time and resources, both in terms of personnel and infrastructure, to make use of their repository data. Even getting answers to simple questions may require significant effort.

Bots have been proposed as a means to help automate redundant development tasks and lower the barrier to entry for information extraction. Hence, recent work laid out a vision for how bots can be used to help in testing, coding, documenting, and releasing software. However, no prior work applied and evaluated the use of bots on software repositories. This section provides a brief background of bots in prior works, highlighting how these works identify a need for bots used to mine software repositories.

Bots have been defined as tools that perform repetitive predefined tasks to save developer's time and increase their productivity and at least five areas have been identified where bots may be helpful: code, test, DevOps, support, and documentation. In fact, there exist a number of bots, mostly enabled by the easy integration in Slack that fit into each of the aforementioned categories. For example, BugBot is a code bot that allows developers to create bugs easily. Similarly, Dr. Code is a test bot that tracks technical debt in software projects. Many other bots such as Pagerbot can notify developers whenever a special action happens. One key characteristic of these bots is that they simply automate a task, and do not allow developers or users to extract information, or in other words, ask questions and have them answered. Accordingly, there is an unmet need for a bot framework that is able to intelligently answer questions based on the repository data of a specific project.

Prior work has also laid out visions for future uses of bots. Early work on bots presented a cognitive support framework in the bots landscape. Other researchers have proposed work that laid out the vision for the integration of bots in the software engineering domain. For example, researchers have proposed the idea of code drones, a new paradigm in which each software artifact represents an intelligent entity. The authors outline how these code drones interact with each other, updating and extending themselves to simplify the developer's life in the future. An analysis bot platform called Mediam allows developers to upload their project to GitHub has been envisioned. The platform would allow multiple bots to run on them and generate reports that provide feedback and recommendations to developers. The key idea of the vision is that bots can be easily developed and deployed, allowing developers quick access to new methods developed by researchers. A future system (OD3) that produces documentation to answer user queries has also been envisioned. The proposed documentation would be generated from different artifacts such as source code, Q&A forums, etc. These proposed projects are united by the fact that they see the use of bots as a key to bringing their vision to life. They are also merely proposals: there exists a need to implement these visionary projects.

Prior researchers have also built various approaches to help developers answer questions they may have. For example, a semantic search engine framework that retrieves relevant answers to user's queries from software threads has been proposed. Researchers have also proposed a Replay Eclipse plugin, which captures the fine-grained changes and views them in chronological order in the integrated drive electronics (IDE). Replay may help developers answer questions during development and maintenance tasks. A technique that extracts the development tasks from documentation artifacts to answer developers' search queries has been proposed.

Further prior work has applied bots in the software engineering domain. In research to better understand human-bot interaction, a bot that impersonated a human and answered simple questions on Stack Overflow was deployed. Although this bot performed well, it faced some adoption challenges after it was discovered that it was a bot. Similarly, AnswerBot is a bot that can summarize answers extracted from Stack Overflow related to a developers' questions in order to save the developer time. APIBot is a framework built on the SiriusQA assistant that is able to answer developers' questions on a specific API using the API's documentation. APIBot includes a “Domain Adaption” component that produces the questions patterns and their answers. A recent survey found that 26% of examined OSS projects on GitHub used bots to automate repetitive tasks, such as reporting continuous integration failures.

Although applying bots on software repositories may seem similar to using them to answer questions based on Stack Overflow posts, the reality is there are significant differences between the two applications. One fundamental difference is the fact that bots that are trained on Stack Overflow data can provide general answers and will never be able to answer project-specific questions such as “how many bugs were opened against my project today?” There is also a need to better understand how bots can be applied on software repository data and highlight what is and what is not achievable using bots on top of software repositories.

The prior art presents an unmet need for using bots to automate and ease the process of extracting useful information from software repositories. Such work has the potential to transform the MSR field by significantly lowering the barrier to entry, making extraction of useful information from software repositories as easy as chatting with a bot.

### SUMMARY

The present disclosure addresses the shortcomings of current systems and methods for mining software repositories described above. Accordingly, this disclosure describes how bots may be used to automate and ease the process of extracting useful information from software repositories. It lays out an approach of how bots, layered on top of software repositories, can be used to answer some of the most common software development/maintenance questions facing developers.

The present disclosure shares overarching goals with some of the prior art discussed above, but has significant differences. First, in the present disclosure bots are applied on software repositories, which brings different challenges (e.g., having to process the repos and deal with various numerical and natural text data) than those experienced by bots trained on natural language from Stack Overflow. However, this work complements the work that supports developer questions from Stack Overflow. Second, the present disclosure is fundamentally different, because its goals include helping developers interact and get information about their project from internal resources (i.e., their repository data, enabling them to ask questions such as “who touched file x?”), rather than from external sources such as Stack Overflow or API documentation that do not provide detailed project-specific information. Third, the present disclosure contributes to the MSR community by laying out how bots can be used to support software practitioners, allowing them to easily extract useful information from their software repositories.

In one aspect, the present disclosure relates to a non-transitory memory storing code which, when executed by a processor, provides a bot configured to return a reply message to a user question regarding information stored in a software repository. The bot may include the following elements: an entity recognizer configured to extract one or more entities from the user question; an intent extractor configured to extract an intent from the user question; a knowledge base configured to: receive the entities and intent as inputs; interface with at least one of a bug report database, a software repository, and a linking module; and output data; the linking module configured to store linking information relating entries of the bug report database to entries of the bug report database; the bug report database interface configured to query a bug report database and return relevant entries of the bug report database; the software repository interface configured to query a software repository and return relevant entries of the software repository; and a response generator configured to synthesize the reply message using the data.

In another aspect, the present disclosure relates to a method of answering a user question regarding information stored in a software repository using a bot. The method may include the following steps: extracting one or more entities and an intent from the user question; querying a software repository and a bug report database using the entities and the intent; retrieving data from the software repository and the bug report database; synthesizing the data from the software repository and the bug report database; and generating a reply to the question based on the intent and the data. The software repository and the bug report database may be linked.

Additional aspects and advantages of the present disclosure will be apparent from the following description and claims.

### BRIEF DESCRIPTION OF THE DRAWINGS

FIG. 1 is a system for answering user questions using a bot.

FIG. 2 is a user interaction component.

FIGS. 3-6 are charts containing information about a case study on a bot in accordance with the present disclosure.

Tables 1-2 contain information about a case study on a bot in accordance with the present disclosure.

### DETAILED DESCRIPTION

In general, the present disclosure relates to the use of bots for automating and easing the process of extracting useful information from software repositories. The following description will first describe the design and implementation of a bot approach for software repositories. Components of the bot approach will be described in detail, as will systems and methods incorporating the bot approach. The description will then turn to the evaluation of the bot approach outlined above to demonstrate its effectiveness, efficiency and accuracy and compare it to a baseline. Finally, the description will summarize applications for the systems and methods presented herein and advantages that they provide over the current art.

The term bot is used throughout the present disclosure. In general, a bot may be a software application that runs automated scripts. Non-transitory memory may store code, which, when executed by a processor, may provide a bot, as described herein.

As discussed above, a key component of the present disclosure is a bot that users can interact with to ask questions to their software repositories and associated bug report databases. The present disclosure also relates to systems which include such bots and methods which make use of such bots and/or accomplish the functionality of such bots through other means.

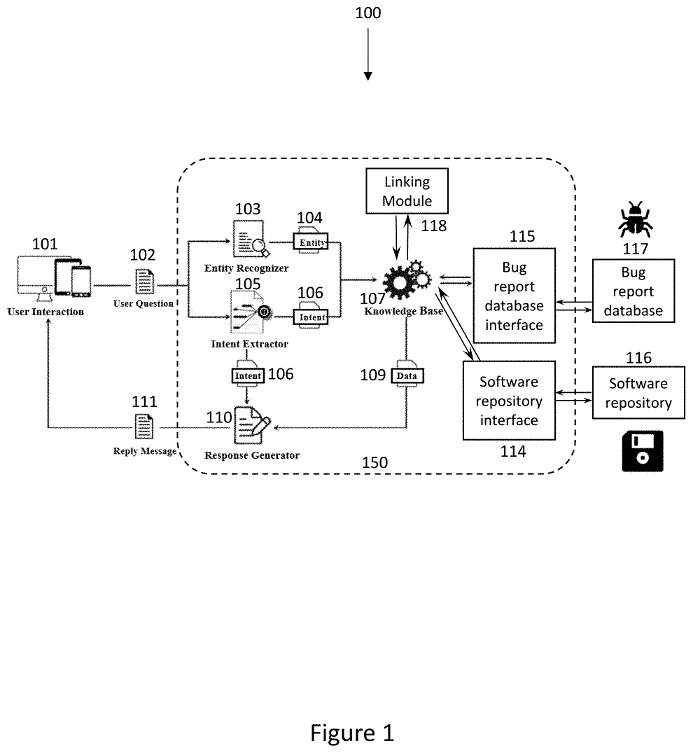

FIG. 1 is a schematic representation a system 100 for answering user inquires about bug reports and related software updates using a bot 150. The bot 150 may receive a user question 102 as an input and provide a reply message 111 as an output. The bot 100 may include four key components: (1) an entity recognizer 103 which produces an entity 104; (2) an intent extractor 105 which produces an intent 106; (3) a knowledge base 107 which communicates with a software repository interface 114, a bug report database interface 115, and a linking module 118 to produce data 109; and (4) a response generator 110 which produces a reply message 111 based on the data 109 and the intent 106. The system 100 may further include three other components: (1) a user interaction component 101 which produces the user question 102 and displays the reply message 111; (2) a software repository 116; and (3) a bug report database 117. Each of these parts will be detailed in the following paragraphs.

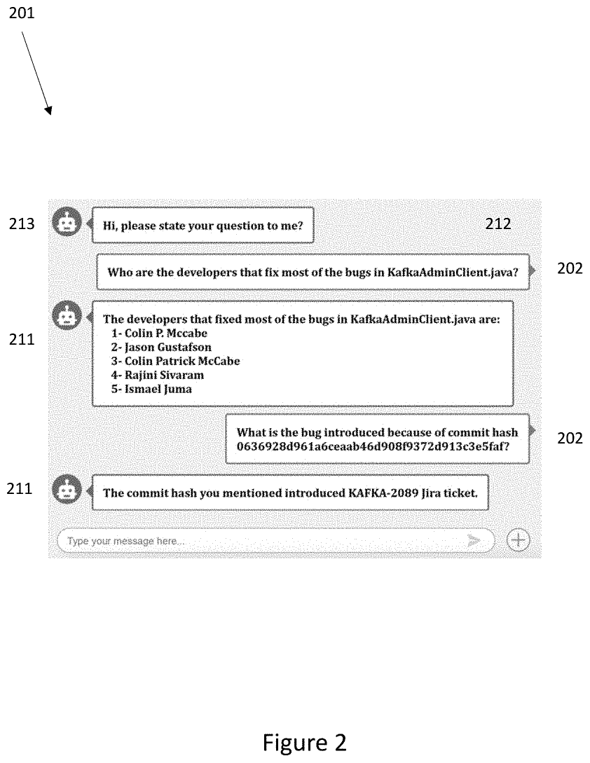

In some embodiments, a bot may be configured to answer questions about a software repository and a bug report database. FIG. 2 illustrates such an embodiment: the bot 200 interacts with a software repository 214 and a bug report database 215 to answer the user question (not illustrated). In such embodiments, the software repository 214 and the bug report database 215 may contain linked information. Accordingly, the components of the bot 200 may be configured interact with both the software repository 214 and the bug report database 215, to form or follow links between the software repository 214 and the bug report database 215, and to synthesize an answer to the user question based on information from the software repository 214 and the bug report database 215.

Bots and systems in accordance with the present disclosure will be described in detail in the following paragraphs. The components listed above will be described in detail, including the interaction of the bot with the software repository and the bug report database. This description will begin with the user interaction component 101 and cycle through the remaining components as illustrated in FIG. 1. This order may mirror the order in which the components may be used if the bot 150 answers a user question 102.

The user interaction component 101 may allow a human user to effectively interact with the bot framework. This may be done in a variety of different ways, for example, through natural language text, through voice and/or visualizations. The user interaction component 101 may be implemented on a variety of different hardware, such as a phone, tablet, or computer. In some embodiments, the user interaction component 101 may comprise a window presented to the user on such a device. The user may be able to input a question into the window through typing, using voice dictation, or using any other means known in the art. In addition to handling user input, the user interaction component 101 may also present the reply message 111 to the user. The reply message 111 and the method by which it is produced will be described in detail below. The system 100 may be configured so that users may pose their questions in their own words. Accordingly, the user interaction component 101 may be configured to accept any words which user may present as the user question 102. Natural language can be complicated to handle, especially because different people can pose the same question in many different ways. To handle this diversity in the natural language questions, the system 100 may rely on an entity recognizer 103 and an intent extractor 105, which extract structured information from the unstructured language of the user question 102. These components will be detailed in the next subsections. The user interaction component 101 may deliver the user question 102 to the entity recognizer 103 and the intent extractor 105 through any means known in the art.

FIG. 2 illustrates an exemplary user interaction component 201. The user interaction component 201 may include a window 212 which may be presented to a user on a device such as a computer (not illustrated). The bot may produce a prompt 213 in the window 212. In some embodiments, the prompt 213 may appear as a text box instructing the user to input a question. In other embodiments, the prompt 213 may be graphical or auditory, or may take some other form. The user may produce a user question 202. In some embodiments, the user question 202 may appear as a text box in the window 212 showing the text input by the user. The bot may provide a reply message 211 in response to the user question 202. The method of determining the reply message 211 will be detailed below. In some embodiments, the reply message 211 may appear as a text box in the window 212 showing the text of the reply. One skilled in the art will recognize that there are myriad ways to prompt a user to input a question, to display a question asked by the user, and to display an answer to that question, and will understand that any of these ways fall within the scope of the present disclosure. Accordingly, a user interaction component 201 may not take the form of a window 212 with textboxes.

The entity recognizer 103 may identify and extract the useful information, or in other words, the entity 104, that a user mentioned in the user question 102 and categorize the extracted entity 104 into a particular type (e.g. city name, date, and time). In some instances, the entity recognizer 103 may identify and categorize more than one entity 104. The entity recognizer 103 may use any method known in the art to perform the extraction. For example, the entity recognizer 103 may use Named Entity Recognition (NER). There are two main NER categories: Rule-Based NER and Statistical NER; the entity recognizer 103 may use either one. In the rule-based NER, the user may come up with different rules to extract the entities while in the statistical NER the user may train a machine learning model on an annotated data with the named entities and their types in order to allow the model to extract and classify the entities.

The extracted entity 104 may be transmitted to the knowledge base 107 through any means known in the art and may help the knowledge base 107 in answering the user question 102. For example, in the question: “Who modified Utilities.java?”, the entity 104 is “Utilities.java” which may be of type “File Name.” Having the file name may be necessary to know which file the user is asking about in order to answer the question correctly (i.e. bringing information of the specified file). However, knowing the file name (entity) may not be enough to answer the user's question. Therefore, an intent extractor 105, which extracts the user's intention 106 from the posed question 102, may also be necessary. This component is detailed below.

The intent extractor 105 may extract the user's purpose/motivation (intent 106) from the user question 102. In the last example, “Who modified Utilities.java?”, the intent 106 may be to know the commits that modified the Utilities file. An exemplary approach to extracting the intent 106 is to use Word Embeddings, and more precisely, the Word2Vec model. The model may take a text corpus as input and output a vector space where each word in the corpus is represented by a vector. In this approach, the developer may need to train the model with a set of sentences for each intent (training set). Where those sentences express the different ways that the user could ask about the same intent (same semantic). After that, each sentence in the training set is represented as a vector using the following equation:

$$Q \text{?} = {\sum }_{j = 1}^{n} Q \text{?} Where Q \text{?} \text{?} VS \\ \text{?} \text{indicates text missing or illegible when filed} \qquad ( 1 )$$

where Q and Q_{wj} represent the word vector of a sentence and vector of each word in that sentence in the vector space VS, respectively. Afterwards, the cosine similarity metric may be used to find the semantic similarity between the user's question vector (after representing it as a vector using Equation 1) and each sentence's vector in the training set. The intent of the user question 102 may be the same as the intent of the sentence in the training set that has the highest score of similarity. The extracted intent 106 may be forwarded to the response generator 110 in order to generate a response/reply message 111 based on the identified intent 106. The intent 106 may also be forwarded to knowledge base 107 in order to answer the user question 102 based on its intent. The knowledge base 107 and the response generator 110 are detailed below.

If the intent extractor 105 is unable to identify the intent 106 (low cosine similarity with the training set), it may notify the knowledge base 107 and the response generator 110, and they may respond with some default reply.

In some embodiments, the system 100 and the bot 150 may be configured such that a user may ask a series of related questions. For example, a first user question may ask about the author of a software update and a second user question may ask if “she” has made any bug reports. In this instance, “she” in the second question refers to the author identified by the first question. To handle situations like this, the bot 150 may include one or more memory components configured to store information about previous questions and answers in a session. The entity recognizer 103 and the intent extractor 105 may access the memory component(s) when analyzing a new user question 102. Accordingly, the entity 104 and the intent 106 may be based on information stored in memory if the user question 102 references that information.

The knowledge base 107 may be responsible for retrieving and returning data 109 which provides an answer to the user question 102. The knowledge base 107 may do this by interacting with a software repository interface 114, a bug report database interface 115, and a linking module 118. User questions 102 may require information regarding both software updates and bug reports, accordingly requiring the knowledge base 107 to acquire/compile/synthesize information from multiple sources to provide the output data 109.

The knowledge base 107 may take the extracted entity 104 and the extracted intent 106 transmitted from the entity recognizer 103 and the intent extractor 105 as inputs. The entity 104 may be used as a parameter for the query or call and the intent 106 may be used to determine the nature of the query or call. For example, if a user asks the question “Which commits fixed the bug ticket HHH-11965?” then the intent 106 may be to get the fixing commits and the issue key “HHH-11965” is the entity 104. In this example, the knowledge base 107 queries the bug report database interface 115 and/or the software repository interface 114 on the fixing commits that are linked to Jira ticket “HHH-11965.”

As discussed above, the knowledge base 107 may interact with the linking module 118, the bug report database interface 115, and the software repository interface 114 to retrieve data 109 which may contain/provide an answer to the user question 102 as represented by the entities 104 and the intent 106. The bug report database interface 115 may be configured to query a bug report database 117, which may contain a series of entries, each entry containing a bug report and related information. For example, an entry in the bug report database 117 may include a bug report, the author of the bug report, the date and time at which the bug report was made, and/or other information about the bug report. The software repository interface 114 may be configured to query a software repository 116, which may contain a series of entries, each entry containing a software update and related information. For example, an entry in the software repository 116 may include a software update, the author of the software update, the date and time at which the software update was published, and/or other information about the software update. The interfaces 114, 115 may be configured to query the software repository 116 and the bug report database 117 using any means known in the art. One skilled in the art will recognize that there are myriad methods by which a software module may query a repository, database, or other collection of information; any such methods may be used in accordance with the present disclosure. Further, bug reporting and software update organizing software is well known in the art, and any type of software may be used to compile the database 117 and the repository 116. Any type of bug report database and software repository falls within the scope of the present disclosure.

The bug report database 117 and the software repository 116 may be linked to each other because the software updates in the software repository 116 may solve the problems reported in bug reports in the bug report database 117. In some embodiments, entries in the software repository 116 may include index information about which bug report they solve; the index may provide a link between the bug report database 117 and the software repository 116. In some embodiments, the linking module 118 may create links between the software repository 116 and the bug report database 117. In some embodiments, the linking module 118 may search the bug report database 117 for related entries whenever a new entry is added to the software repository 116. If one or more related entries are found in the bug report database 117, the linking module 118 may store linking information about the new entry and the related entries. The linking module 118 may perform a similar operation whenever a new entry is added to the bug report database 117.

Whenever an intent 106 and one or more entities 104 are provided to the knowledge base 107, the knowledge base 107 may analyze these inputs to determine whether an initial query should be made to the bug report database 117, the software repository 116, or both. This decision may be made based on the entities 104. For example, if the entities 104 are only related to bugs, the initial query may be made to the bug report database 117. Based on this determination, the knowledge base 107 may interact with either the bug report database interface 115, the software repository interface 114, or both. The interface(s) 114, 115 may query the bug report database 117 and/or the software repository 116 using the entities 104 and the intent 106. The interface(s) 114, 115 may return one or more relevant entries in the bug report database 117 and/or the software repository 116 to the knowledge base 107 based on the entities 104 and the intent 106.

As discussed above, answering the user question 102 may require retrieving information from both the bug report database 117 and the software repository 116. If the knowledge base 107 only activates one of the bug report database interface 115 and the software repository interface 114, the knowledge base 107 may use the linking module 118 to find related entries whichever of the bug report database 117 and the software repository 116 which has not been queried. The related entries may be returned to the knowledge base 107.

As discussed above, knowledge base 107 may output data 109. In some embodiments, this data 109 may be the information retrieved from the software repository 116 and the bug report database 117. In some embodiments, the knowledge base 107 may process the retrieved information before outputting it as data 109. For example, the knowledge base 107 may combine or merge information from the software repository 116 with information from the bug report database 117. The knowledge base 107 may pass the data 109 to the response generator 110.

In an exemplary case, a user question 102 may ask about the author of software fixing a particular bug. In this case, the knowledge base 107 may determine that the initial query should be made to the bug report database 117. The bug report database interface 115 may query the bug report database 117 to identify an entry related to the bug named in the user question 102. However, the answer to the user question 102, namely the author of the software fixing the identified bug, may be contained in the software repository 116, not the bug report database 117. Accordingly, the linking module 118 may have formed a link from the identified entry in the bug report database 117 to a corresponding entry in the software repository 116 which relates to the software which fixes the identified bug. This entry may include information about the author of the software. The knowledge base 107 may use the linking module 118 to follow this link from the entry in the bug report database 117 to the corresponding entry in the software repository 116. The software repository interface 114 may retrieve the author from the software repository 116. The knowledge base 107 may pass this information to the response generator 110 as data 109.

The knowledge base 107 may forward the data 109 which results from the interaction with the external source 108 (query/call) to the response generator 110 to generate a reply message 111 to the user question 102. In case the intent extractor 105 was unable to identify the intent 106, the knowledge base 107 may do nothing and wait for a new intent 106 and entities 104. Furthermore, the knowledge base 107 may verify the presence of the entities 104 associated with the extracted intent 106 and may notify the response generator 110 if the entities 104 are missing or if the knowledge base 107 is unable to retrieve the data 109 from the external source 108. The response generator 110 is described below.

The response generator 110 may generate a reply message 111 that contains the answer to the user question 102 and sends it to the user interaction component 101 to be viewed by the user. The response/reply message 111 may be generated based on the user question 102 asked, and more specifically, the extracted intent 106 of the question. In some cases, the bot may not be able to respond to a user question 102 (e.g., if it is not possible to extract the intent or if entities are missing). In such cases, the response generator 110 may return a default response/reply message 111 such as: “Sorry, I did not understand your question, could you please ask a different question?”

As discussed above, in some embodiments, the data 109 passed to the response generator 110 may include data 109 retrieved from both a bug report database 117 and a software repository 116. In such embodiments, the response generator 110 may synthesize data 109 from both sources and from the intent 106 to generate the response. In the example presented above, in which the user question 102 references the author of software which fixes a particular bug, the response generator 110 may synthesize a response regarding the particular bug (from the bug report database 117) and the author (from the software repository 116). The above description has detailed a system 100 configured to answer a user question using a bot 150. The present disclosure also relates to methods of answering user questions using bots. Such methods may or may not use the system 100 described above.

In general, a method in accordance with the present disclosure may include the following steps. A question may be received from a user. In some embodiments, the question may be received in response to a prompt; in other embodiments, the question may be received without prompting. Receiving a question may entail receiving a text input, oral input, graphical input, or other form of input. An entity and an intent may be extracted from the question using any means known in the art. An external source such as a database may be queried using the entity and the intent. Results of the query may be used to answer the question. A reply message may be formulated. If the question has been answered, the reply message may contain the answer; if the question could not be answered, the reply message may state that. One skilled in the art will recognize that a method in accordance the present disclosure may include a subset of the steps below and/or may also include steps not described above. Further, the steps may be performed in the order presented, or may be performed in any other order.

Case Study

A case study was performed to determine the efficacy of the system and method described above and results of the case study were promising. The case study is described in detail below. The case study used one exemplary embodiment of the system disclosed herein, and thereby provides a practical example of how the system may be implemented. One skilled in the art will recognize that the system and method of the present disclosure may be implemented in myriad different ways, using different hardware and software. Such implementations may not be detailed herein, but they do fall within the scope of the disclosure.

To determine whether using bots helps answer questions based on repository data, researchers performed a user study with 12 participants. Researchers built a web-based bot application that implemented our framework and had users directly interact with the bot through this web-application. This interface is shown in FIG. 2 and described above; it was also made publicly available online.

To extract the intents and entities, researchers leveraged Google's Dialogflow engine. Dialogflow has a powerful natural language understanding (NLU) engine that extracts the intents and entities from a user's question based on a custom NLP model. The choice to use Dialogflow was motivated by the fact that it can be integrated easily with 14 different platforms and supports more than 20 languages. Furthermore, it provides speech support with third-party integration and the provided service is free. These features make it easier to enhance our framework with more features in the future.

Any NLU model needs to be trained. To train the NLU, researchers followed the approach laid out by C. Toxtli, et. al. (C. Toxtli, A. Monroy-Hernandez, and J. Cranshaw. Understanding chatbot-mediated task management. In Proceedings of the 2018 CHI Conference on Human Factors in Computing Systems, CHI '18, pages 58:1-58:6, New York, N.Y., USA, 2018. ACM.). Typically, the more examples the NLU is trained on, the more accurately the NLU model can extract the intents and entities from the user questions. Researchers used an initial set to train the NLU and asked two developers to test the bot for one week. During this testing period, researchers used the questions that the developers posed to the bot to further improve the training of the NLU.

Although researchers used Dailogflow in this implementation, it is important to note that there exist other tools/engines that one can use such as Gensim, Stanford CoreNLP, Microsoft's LUIS, IBM Watson, or Amazon Comprehend. These tools and any others known in the art may be used within the scope of the present disclosure.

To ensure that the usage scenario of the Bot is as realistic as possible, researchers had the participants ask questions that have been identified in the literature as being of importance to developers and use repository data from real projects, in this case Hibernate-ORM and KAFKA. To compare, researchers also asked the participants to answer the same questions without using the bot, and called this the baseline comparison.

Table 1 presents the questions used in the case study and the rationale for supporting the question. Each question represents an intent and the bold words represent the entities in the question. For example, the user could ask Q8 as: “What are the buggy commits that happened last week?”, then the intent is “Determine Buggy Commits” and the entity is “last week”. It is important to emphasize that the bot's users can ask the questions in different ways other than what is mentioned in Table I. In the last example the user can ask the bot “What are the changes that introduced bugs on Dec. 27, 2018” where the intent remains the same although the question is asked in a different way and the entity is changed to a specific date (Dec. 27, 2018).

Although the exemplary bot supports 15 questions in this case study, it is important to note that the bot framework of this disclosure can support many more questions. Researchers opted to focus on these 15 questions since the goal was to evaluate the bot in this research context and they wanted to keep the evaluation manageable.

Once researchers decided on the 15 questions to support, they demonstrated the usefulness of the bot through a user study.

In addition to getting the bot to answer questions posed by the participants, researchers also got the participants to answer the same questions they asked to the bot manually (to have a baseline comparison). For the baseline evaluation, researchers posed the exact questions (shown in Table 1) to the participants, so they know exactly what to answer to. The participants were free to use any technique they prefer such as writing a script, performing web searches, executing Git/Jira commands, or searching manually for the answer in order to find the answer to questions, as the goal was to resemble as close to a realistic situation as possible.

Bots are typically evaluated using factors that are related to both, accuracy and usability. Particularly, prior work suggested two main criteria when evaluating bots: (1) usefulness, which states that the answer (provided by the bot) should include all the information that answers the question clearly and concisely; and (2) speed: which states that the answer should be returned in a time that is faster than the traditional way that a developer retrieves information. In essence, bots should provide answers that help with the questions and do this in a way that is faster than if you were not using the bot. In addition to the two above evaluation criteria, researchers added another criteria, related to the accuracy of the answers that the bot provides. In this case, researchers define accuracy as the number of correct answers returned by the bot to the user, where the returned answer is marked correct if it matches the actual answer to the question.

The 12 participants asked the bot 144 questions (some developers asked more than 10 questions). Of the 144 questions, the bot provided a response to the users 123 times. Researchers examined the remaining 21 questions that were not answered, and noticed that 19 questions were out of scope, and in the remaining 2 questions, the bot encountered a connection issue to the internet. For this reason, researchers removed the 21 questions from the analysis and all of the presented results are based on the 123 questions that are relevant.

Results are now presented regarding how useful the bot's answers were to user questions. As mentioned earlier, one of the first criteria for an effective bot is to provide its users with useful answers to their questions. Evaluating a bot by asking how useful its answers were commonly used in most bot-related research.

Participants were asked to indicate the usefulness of the answer provided by the bot after each question they asked. The choice was on a five-point Likert's scale from very useful (meaning, the bot provided an answer they could actually act on) to very useless (meaning, the answer provided does not help answer the question at all). The participants also had other choices within the range, which were: useful (meaning, the answer was helpful but could be enhanced), fair (meaning, the answer gave some information that provided some context, but did not help the answer fully) and useless (meaning, the reply did not help with the question, but a reply was made).

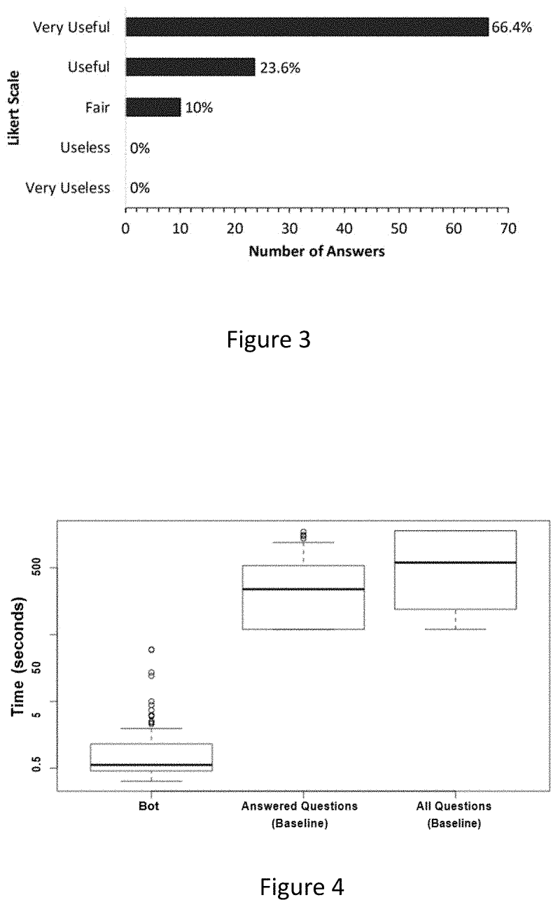

FIG. 3 shows the usefulness results in case they were correct. Overall, 90.0% of the participants indicated that the results returned by the bot were considered to be either useful or very useful. Another 10.0% indicated that the bot provided answers that were fair, meaning the answers helped, but were not particularly helpful in answering their question. Results did not consider the incorrect answers returned by the bot because the returned answers will not be related to the posed questions which make them not useful to the participants.

Upon closer examination of the fair results, researchers found a few interesting reasons that lead users to be partially dissatisfied with the answers. First, in some cases, the users found that the information returned by the bot to not be easily understandable. For example, if a user asks for all the commit logs of commits that occurred in the last year, then the returned answer will be long and terse. In such cases, the users find the answers to be difficult to sift through, and accordingly indicate that the results are not useful. Such cases showed us that perhaps we need to pay attention to the way that answers are presented to the users and how to handle information overloading. Researchers plan to address such issues in future versions of the bot framework. Another case is related to information that the users expected to see. For example, some users indicated that they expect to have the commit hash returned to them for any commit-related questions. Initially, researchers omitted returning the commit hashes (and generally, identification info) since they felt such information is difficult to read by users and envisioned users of the bot to be more interested in summarized data (e.g., the number of commits that were committed today). Clearly, the bot proved to be used for more than just summarized information and in certain cases users were interested in detailed info, such as a commit hash or bug ID. All of these responses provided researchers with excellent ideas for how we will evolve the bot.

Results are now presented regarding how fast the bot replied to the users' questions. Because bots are meant to answer questions in a chat-like forum, speed is of the essence. Therefore, RQ2 aims to shed light on how fast the bot can provide a reply to users and compares that to how fast users can obtain a result without the bot (i.e., the baseline).

Researchers measure the speed of the bot's replies into two ways. First, they instrument the bot framework to measure the actual time it took to provide a response to users. Second, they ask the users to indicate their perceived speed of the bot.

FIG. 4 shows box plots of the time it took for the bot to provide a reply and compares it to the case where a bot was not leveraged (note that the y-axis is log-scaled to improve readability). As evident from FIG. 4, the bot (the left most box plot) significantly outperforms the baseline approach, achieving a median response time of 0.55 seconds and a maximum of 30 seconds. On the other hand, for the baseline approaches, researchers have two results: one that considers all questions that users were able to answer (labeled “Answered questions (baseline)” in FIG. 4) and the other considering all questions, i.e., answered and not answered (labeled “All questions (baseline)” in FIG. 4). Since researchers gave a maximum of 30 minutes for participants to answer a question, questions that were not answered after 30 minutes were considered to have taken 30 minutes. The median times for the case where only the answered questions are considered is 240 seconds and the maximum is 1,740 seconds. The median time when all questions (answered and unanswered) are considered is even higher, achieving a median of 600 seconds and a maximum of 1,800 seconds. To ensure that the difference between the bot and the two baselines is statistically significant, researchers performed a wilcox test, and the difference in both cases (i.e., bot vs. answered questions and bot vs. all questions) was determined to be statistically significant (i.e., p-value 0.01).

Researchers also quantified how users perceived the speed of the bot to be. To accomplish this, researchers asked users to indicate how fast they received the answer to their question from the bot. Once again, the choices for the users were given on a five-point Likert's scale, from very fast (aprox. 0-3 seconds) to very slow (30 seconds). The participants also had other choices within the range, which were: fast (4-10 seconds), fair (11-20 seconds) and slow (21-30 seconds).

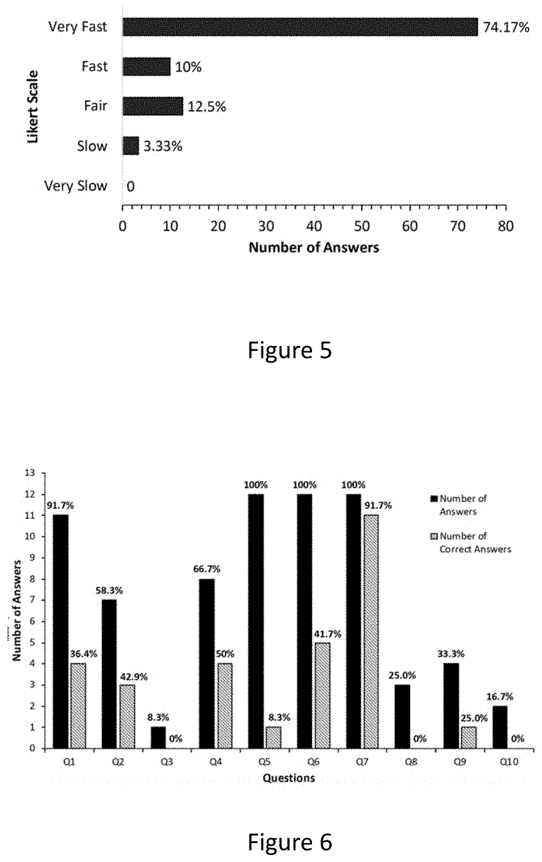

FIG. 5 shows the results of the survey participants. The majority of the responses (84.17%) indicated that the bot's responses were either, fast or very fast. The remaining 15.83% of the replies indicated that the bot's response was either fair or slow. Clearly, our answers show that the bot provides a significant speed up to users.

To better understand why some of the questions took longer to reply by the bot, researchers looked into the logged data and noted 4 cases that may have impacted the response speed of the bot. Researchers found that in those cases, Dialogflow took more than 10 seconds to extract intents and entities from the user's question. They searched for the reasons for Dialogflow's delay and that the way users ask questions can make it difficult for Dialogflow's algorithms that extract the entities and intents. In other cases, the answer to the questions required the execution of inner joins, which caused a slowdown in the response from the knowledge base.

As for the case where users took a long time to find that answers in the baseline case, researchers found that the main reason for such delays is that some questions were more difficult to answer, hence, users needed to conduct online searches of ways/techniques that they can use to obtain the answer.

Overall, the bot was fast in replying to user's questions. Moreover, it is important to keep in perspective how much time the bot saves. As researchers learned from the feedback of the baseline experiments, in many cases, and depending on the question being asked, a developer may need to clone the repository, write a short script and process/cleanup the extracted data to ensure it answers their question and that might be a best case scenario. If the person looking for the information is not very technical (e.g., a manager), they may need to spend time to learn what commands they need to run, etc., which may require several hours or days.

Results are now presented regarding the accuracy of the bot's answers. In addition to using the typical measures to evaluate bots, i.e., usefulness and speed, it is critical that the bot returns accurate results. This may be of particular importance in the present case, since software practitioners generally act on this information, sometimes to drive major tasks.

Researchers measure accuracy by checking the answer that the bot provided to the user with the actual answer to question if it was queried manually by cloning the repositories then write a script to find the answer or executing git/Jira commands. For example, to get the developers who touched the “KafkaAdminClient” file, researchers ran the following git command: “git log -pretty=format:%cn-clients/src/main/java/org/a-pache/kafka/clients/admin/KafkaAdminClient.java”. This RQ checks each component's functionality in the framework. Particularly, it checks whether the extraction of the intents and entities is done correctly from the natural language question posed by the users. Moreover, researchers check whether the knowledge base component queries the correct data and the response generator produces the correct reply based on the intent and knowledge base, respectively. In total, researchers manually checked all 123 questions asked to the bot by the participants.

The results showed that the bot correctly answered 87.8% (108 of 123) of the questions. Manual investigation of the correct answers showed that the bot is versatile and was able to handle different user questions. For example, the bot was able to handle the questions “how many commits in the last month” asked by participant 1 vs. “determine the number of commits that happened in last month.” asked by participant 2 vs. “number of commits between Nov. 1, 2018 to Nov. 30, 2018” from participant 3, which clearly have the same semantics but different syntax.

The findings indicate that the 15 wrong answers were returned due to the incorrect extraction of intents or entities by our trained NLU model as shown in Table 2. For example, in one scenario the user asks “Can you show the commits information that happened between May 27 2018 to May 31st 2018?” and our NLU model was unable to identify the entity (because it was not trained on the date format mentioned in the participant's question). Consequently, the knowledge base and the response generator components mapped the wrong intent and returned an incorrect result.

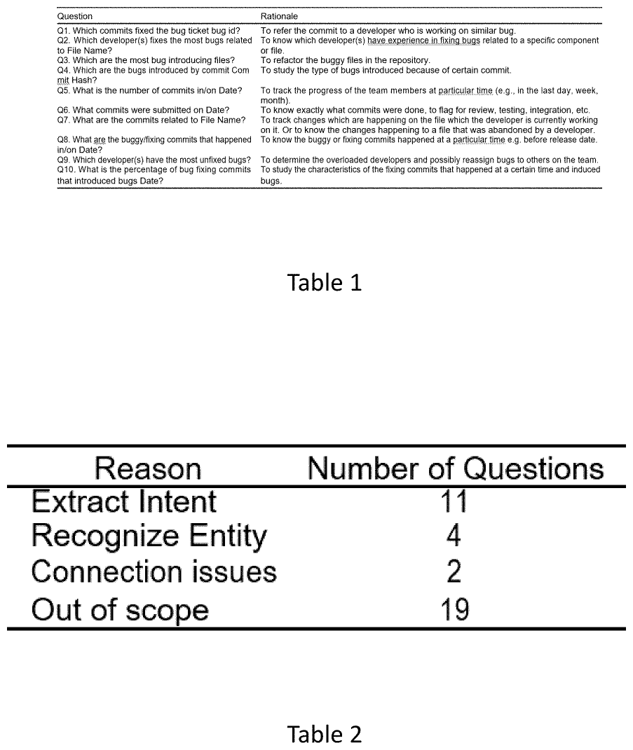

As mentioned earlier, researchers also conducted a baseline comparison where they asked users to provide answers to our questions without the use of the bot. FIG. 6 shows a break down of 1) the number of answers and 2) the number of correct answers per question. On the positive side, the survey participants were able to provide some sort of answer for all questions, albeit some of the questions (e.g., Q3, Q8, Q5 and Q10) had less answers from participants. Across all questions, the participants provided some sort of answer in 62.6% of the cases.

However, interestingly, the number of correct answers is much lower. Across all questions, the survey participants provided the correct answer in 25.2% of the cases. For example, for Q3, Q8 and Q10, all of the provided answers were incorrect. In fact, for Q7 were most of the provided answers correct. This outcome highlights another (in addition to saving time) key advantage of using the bot framework, which is that reduction of human error. When examining the results of the baseline experiments, researchers noticed that in many cases participants would use a wrong command or a slightly wrong date. In other cases where they were not able to provide any answer, they simply did not have the know how or failed to find the resources to answer their question within a manageable time frame.

This case study demonstrates that an exemplary bot in accordance with the present disclosure accurately and quickly answers user questions. Further, it demonstrates that the bot provides a useful service to users who work with software by automating the process of answering questions that may take users a long time to find answers to on their own. Accordingly, bots, systems, and methods in accordance with the present disclosure may present significant advantages over currently used systems and methods.

What is claimed is:

1. A non-transitory memory storing code which, when executed by a processor, provides a bot configured to return a reply message to a user question regarding information stored in a software repository, the bot comprising:
an entity recognizer configured to extract one or more entities from the user question;
an intent extractor configured to extract an intent from the user question;
a knowledge base configured to: receive the entities and intent as inputs; interface with at least one of a bug report database, a software repository, and a linking module; and output data;
the linking module configured to store linking information relating entries of the bug report database to entries of the bug report database;
the bug report database interface configured to query a bug report database and return relevant entries of the bug report database;
the software repository interface configured to query a software repository and return relevant entries of the software repository; and
a response generator configured to synthesize the reply message using the data.

2. The non-transitory memory of claim 1, wherein the linking module is further configured to form links between the entries of the bug report database and the entries of the bug report database.

3. The non-transitory memory of claim 1, wherein the bug report database and the software repository comprise a linking index configured to link the data therein.

4. The non-transitory memory of claim 1, wherein the entity recognizer is further configured to categorize the one or more entities.

5. The non-transitory memory of any of claim 1, wherein the entity recognizer uses rule-based named entity recognition or statistical named entity recognition.

6. The non-transitory memory of any of claim 1, wherein the intent extractor is trained on a training set.

7. The non-transitory memory of any of claim 1, wherein the intent extractor uses a Word2Vec model to extract the intent.

8. The non-transitory memory of any of claim 1, wherein interacting with an external source comprises making an application programming interface call.

9. The non-transitory memory of claim 1, wherein interacting with an external source comprises querying a database.

10. The non-transitory memory of claim 1, wherein the reply message is a pre-set message if an intent cannot be extracted or if data cannot be retrieved.

11. A system for answering a user question regarding information stored in a software repository, the system comprising:
a non-transitory memory according to claim 1; and
a user interaction component configured to receive the user question, transmit the user question to the bot, and display the reply message.

12. The system of claim 11, further comprising the bug report database and the software repository.

13. The system of claim 11, wherein receiving the user question comprises receiving a text input and presenting the reply message comprises displaying a text message.

14. A method of answering a user question regarding information stored in a software repository using a bot, the method comprising:
extracting one or more entities and an intent from the user question;
querying a software repository and a bug report database using the entities and the intent;
retrieving data from the software repository and the bug report database;
synthesizing the data from the software repository and the bug report database; and
generating a reply to the question based on the intent and the data,
wherein the software repository and the bug report database are linked.

15. The method of claim 14, further comprising forming links between entries in the software repository and entries in the bug report database.
